(19) United States
(12) Patent Application Publication
(10) Pub. No.: US 2002/0059303 A1
(43) Pub. Date: May 16, 2002

(54) Multimedia data management system

(76) Inventors: Yoshihiro Ohmori, Kawasaki-shi (JP); Osamu Hori, Yokohama-shi (JP); Koji Yamamoto, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/983,899

(22) Filed: Oct. 26, 2001

(30) Foreign Application Priority Data
Oct. 27, 2000 (JP) 2000-328776

(51) Int. Cl. G06F 7/00

(52) U.S. Cl. 707/104.1

(57) ABSTRACT

A multimedia data management system comprises a search caption selector selecting one of a plurality of search captions having attributes, an inquiry expression generator generating an inquiry expression corresponding to the attribute added to the selected search caption, a database storing various media data and attributes thereof and searched by the inquiry expression, a converter converting the search result to a converted search result by adding a style to the search result, and a result output device displaying the converted search result based on the style added thereto.

### CROSS-REFERENCE TO RELATED APPLICATIONS

This application is based upon and claims the benefit of priority from the prior Japanese Patent Application No. 2000-328776, filed Oct. 27, 2000, the entire contents of which are incorporated herein by reference.

### BACKGROUND OF THE INVENTION

1. Field of the Invention

The present invention relates to a multimedia data management system retrieving a still video, a motion video, a speech, more particularly a multimedia data management system that enables a narrow down search or an analogy search that a user hopes for.

2. Description of the Related Art

A database handling multimedia data is as followed. In other words, a database is expanded so that multimedia data can treat RDB (Relational Data Base). The database is referred to as a RDB expansion database. Another database can design a search inquiry screen and search result display screen on GUI and is referred to as a GUI design database. An interMedia made in Oracle company can be nominated for an example of the RDB expansion database. This database can deal multimedia data such as a still video, a motion video, a speech as being text data. However, it is necessary to make a client program in order to show GUI for requiring an inquiry to the database or multimedia data output as search results to the user with various styles. For this reason, a very high cost is taken for flexibility addressing a customized style.

Further, Notes made in Lotus corporation can be nominated for an example of a GUI design database. According to the GUI design database, GUI elements are arranged on a window displaying a search request of a user and search results. If operations of their elements are programmed with a script language, the search results including multimedia data can be caught by various viewpoints. The operations of the elements, however, must be made with a script language in order to perform a narrow down search and a similar search. A combination of SQL-Server and Access of Microsoft company has similar problems.

As described above, in a conventional multimedia data management system, an operation for a search caption is buried in a script and a program. For this reason, it is difficult to carry out a narrow down search and a similar search for multimedia data having much more abundant expression in comparison with search results obtained by merely a text.

### BRIEF SUMMARY OF THE INVENTION

According to an aspect of the invention, there is provided a multimedia data management system comprising: a search caption selector configured to select one of a plurality of search captions to which attributes are added and which are presented to a user; an inquiry expression generator configured to generate an inquiry expression corresponding to one of the attributes of the search captions; a database which stores various media data and attributes of the media data and is searched by the inquiry expression to output a search result; a converter configured to convert the search result to a converted search result by adding a style to the search result; and a result output device configured to visually output the converted search result based on the style added thereto.

### BRIEF DESCRIPTION OF THE SEVERAL VIEWS OF THE DRAWING

FIG. 1 shows a schematic block diagram of a multimedia data management system according to the first embodiment of the present invention;

FIG. 2 shows an example of a display screen of a multimedia data management system of the first embodiment;

FIG. 3 shows a search caption, a query and a style which are stored in a memory 6 with associating with one another;

FIG. 4 shows an example of an attribute stored in a database 3 of the above system;

FIG. 5 shows an example of a query used for the above system;

FIG. 6 shows an example of search results obtained by the above system;

FIG. 7 shows an example of a style used for the above system;

FIG. 8 shows an example of converted search results obtained by the above system;

FIG. 9 shows an example of a screen setting a change of a style with a search result display 5 of the above system;

FIG. 10 shows an example of a screen displayed the same search results as FIG. 2 in a calendar style;

FIG. 11 shows a flow chart explaining an operation of the above system;

FIG. 12 shows outline configuration to realize temporary memory of data in the above system;

FIG. 13 shows an example of an inquiry screen of a search method according to the second embodiment of the present invention;

FIG. 14 shows an example of a query generated by an inquiry expression generator according to the second embodiment;

FIG. 15 shows a block circuit of a multimedia data management system according to the third embodiment of the present invention;

FIG. 16 shows a flow chart explaining a processing of the system according to the third embodiment;

FIG. 17 shows an item example of metadata for describing the representative frame number in the system according to the third embodiment;

FIG. 18 shows a view for explaining a method of selecting a representative frame picture which is different every time, from a program broadcasted regularly such as dramas in the system according to the third embodiment;

FIG. 19 shows a view for explaining another method of selecting a representative frame picture which is different every time, from a program broadcasted regularly such as dramas in the system of the third embodiment;

FIG. 20 shows an item example of metadata for automatically generating plural representative frame pictures in the third embodiment; and

FIG. 21 shows an item example of the metadata which describes key words corresponding to plural representative frame numbers, respectively, according to the third embodiment.

### DETAILED DESCRIPTION OF THE INVENTION

There will now be described embodiments of the present invention in conjunction with drawings.

### First Embodiment

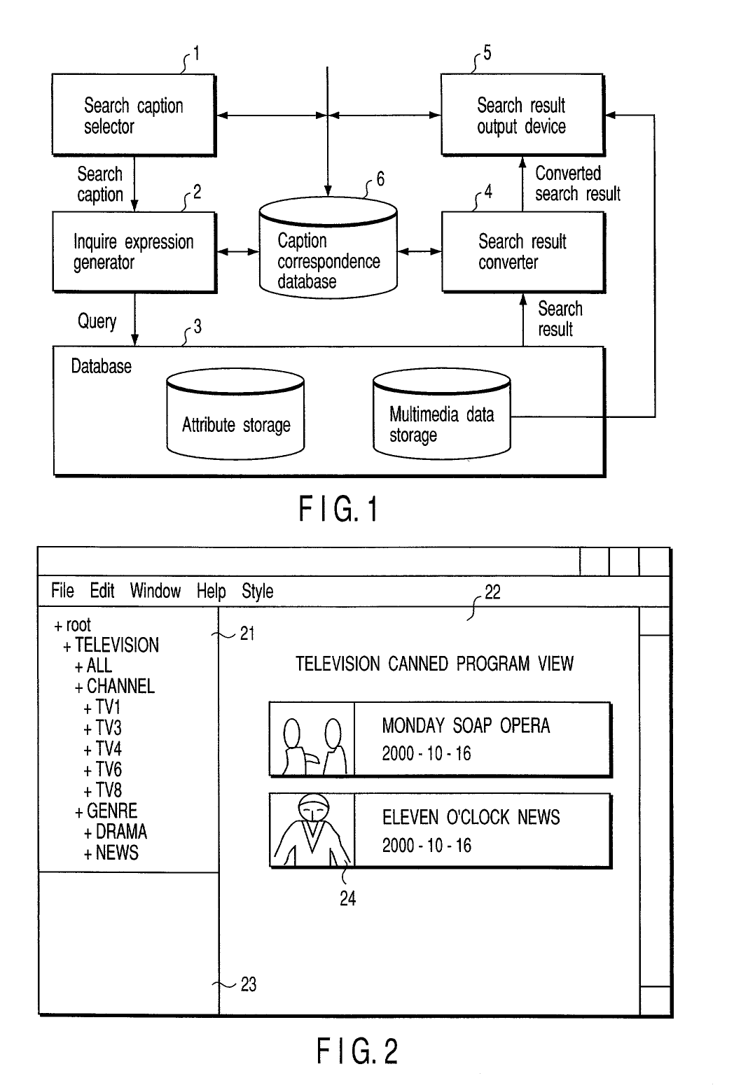

As shown in FIG. 1, a multimedia data management system of the first embodiment comprises a search caption selector 1, an inquiry expression generator 2 receiving the output of the search caption selector 1, a database receiving the output of the inquiry expression generator 2, a search result converter 4 receiving the result from the database 3, a search result output device 5, and a caption correspondence database 6. The caption correspondence database 6 is connected to the search caption selector 1, inquiry expression generator 2, search result converter 4 and search result output device 5.

The search caption selector 1 receives search instructions of a user. The search caption selector 1 comprises GUI elements (referred to “search captions” hereinafter) which are displayed on the screen top of a personal computer, a remote control button, and a sensor worn on the body of a user. In an example of FIG. 2, the search caption selector 1 comprises buttons 21 arranged in a tree-shape and an icon 24 displayed as a search result on the screen 22.

The inquiry expression generator 2 generates in dynamic an inquiry expression (referred to as “query” hereinafter) based on an attribute selected according to a request from the search caption selector 1, and requests a search to the database 3. In other words, the inquiry expression generator 2 generates in dynamic a query corresponding to the search instruction received by the search caption selector 1 on the basis of the search caption attribute added to the selected search caption, and outputs it to the database 3. The query comprises as a function of a program constructing a screen of FIG. 2.

The database 3 stores multimedia data such as a motion video, a still video, a speech, a text, and data attributes. Furthermore, when the database 3 receives a query from the inquiry expression generator 2, an attribute corresponding to the query is retrieved from the database 3, and a result (referred to as “search result”) is output from the database 3 to the search result converter 4. The database 3 comprises as a XML database, for example.

When the search result converter 4 receives the search result from the database 3, it adds an attribute to the search result, and is output the search result to the search result output device 5. The search result output device 5 receives the search result converted by the search result converter 4 (referred to as “converted search result”), and displays the converted search result on, for example, Web browsers to show it to a user. The search result to which a search caption attribute is added comprises as a function of a program constructing a screen of FIG. 2.

The search result output device 5 displays the search result to which an attribute is attended on a screen, to show the search result to a user. The display comprises as a Web browser constructing a screen of FIG. 2, for example.

Referring to FIG. 2, there will now be described a processing wherein a user selects “TV 1” displayed on the screen 21, data corresponding to the “TV 1” are searched, and the result is displayed on the screen 22.

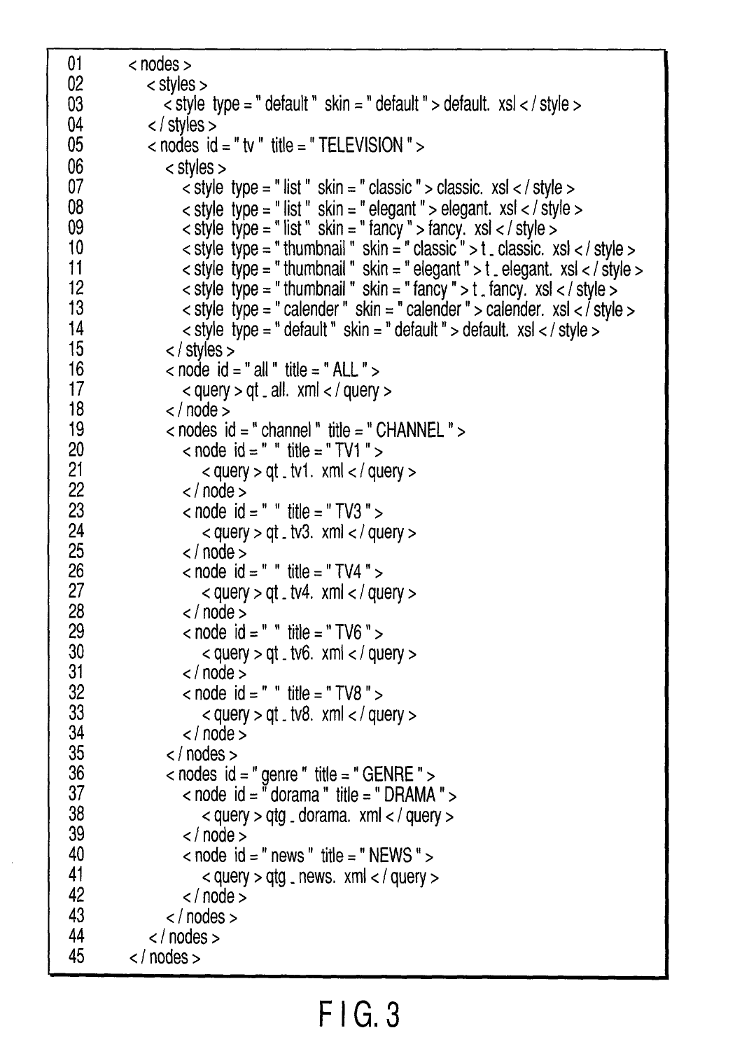

FIG. 3 shows a database in which a search caption and a search caption attribute are stored in association with each other. In FIG. 3, line numbers are referred to the left by reason of convenience of explanation.

The association between the search caption and the search caption attribute is described with XML (Extensible Markup Language) (http://www.w3.org/cf), and stored in the caption correspondence database 6.

A tree-shaped button of the screen 21 is defined by a <nodes> tag and a <node> tag. The <nodes> tag and <node> tag have a title attribute, and a character string to be displayed on the button of the screen 21 is stored between the tags.

The <node> tag can have a <query> tag defining an attribute as an element, and associates the search caption with the search caption attribute. For example, <nodes> defines a format (referred to as “branch tree”) having an element thereunder as being a “television” button of the screen 21, for example. For example, a “root” node of the screen 21 is defined by a line 01. A branch tree included in a root node is described between lines 01 and 45. “Television” of screen 21 is defined between lines 05 and 44. “Channel” is defined from a line 19 to a line 35. “Genre” is defined from a line 36 to a line 43. All these nodes are branch nodes.

A <node> tag defines a button having no element thereunder. For example, “all” is defined from a line 16 to a line 18 and it is a leaf node. “TV 1” is defined from a line 20 to a line 22. “TV 4” is defined from a line 23 to a line 25.

A <query> tag defines an attribute corresponding to a <node> tag. In this example, the attribute is defined by a <query> tag. A file name is stored in a query corresponding to a <node> tag. For example, the “TV 1” button of the screen 21 is defined from the line 20 to the line 22 in FIG. 3, and is associated with a query in the line 21.

As for the search caption selector 1, a <nodes> tag stored in the search caption relation memory 6 and a tree structure based on a <node> tag are arranged as a tree-shaped button as shown in FIG. 2. When a user clicks “TV 1”, the search caption selector 1 selects a file name of “qt_tv1.xml” which means a character string indicating “TV 1” and an attribute from the search caption relation memory 6 and sends it to the query expression generator 2.

The inquiry expression generator 2 generates a query from the attribute. In this example, the inquiry expression generator 2 reads the file of “qt_tv1.xml”, uses it as a query and sends a data retrieve request to the database 3.

The database 3 stores multimedia data and a data attribute corresponding thereto. Furthermore, a query described with XML is input from the query expression generator 2 to the database 3. The attribute of the multimedia data is retrieved from the database 3 according to the query, and the search result described with XML is output from the search result converter 4.

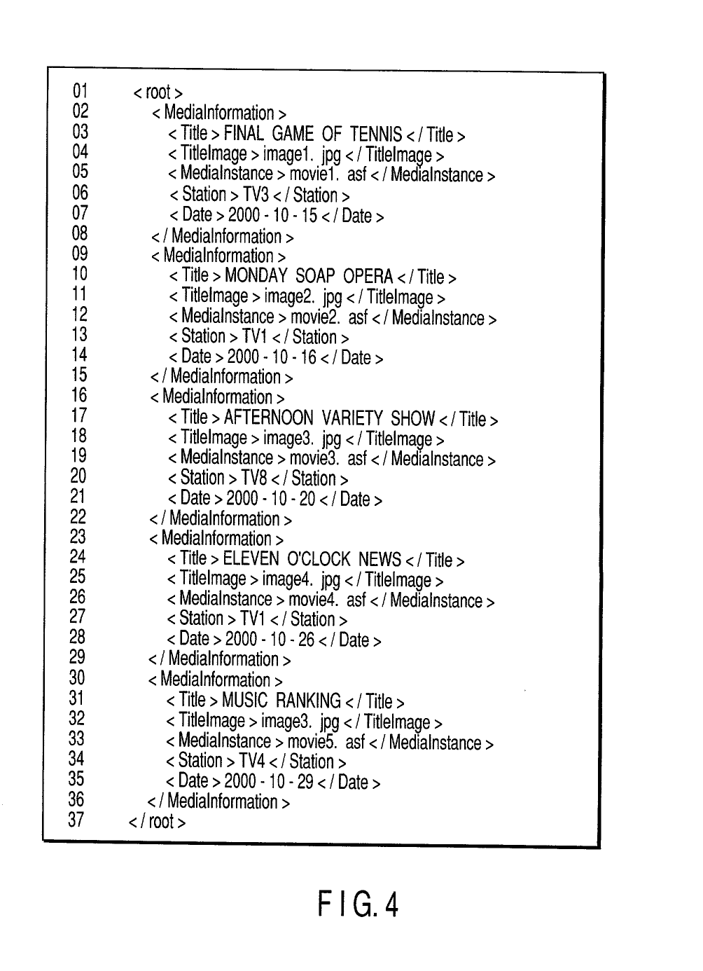

FIG. 4 shows an example of a data attribute stored in the database 3. Line numbers are referred to the left in FIG. 4 for convenience of explanation. The database 3 can store a data attribute in a tree shape, and FIG. 4 shows a tree structure described with XML. A <root> node is the most significant branch, and all data attributes are stored under the most significant branch. In the example of FIG. 4, five <MediaInformation> nodes are stored under a <root> node by the database 3. In other words, the <MediaInformation> node expresses an attribute of one television picture. A position of a video file (<MeidaInstance>), a title (<Title>), a representative picture (<TitleImage>), a TV station excellent (<Station>) a video recording day (<Date>) are stored by database 3. For example, lines from line 02 to line 08 express the data which recorded the finals of tennis from a TV. A video file is “movie1.asf”, a title is “the tennis finals”, a representative picture is “image1.jpg”, a TV station name is “TV 3”, and a video recording day is “Oct. 15, 2000”.

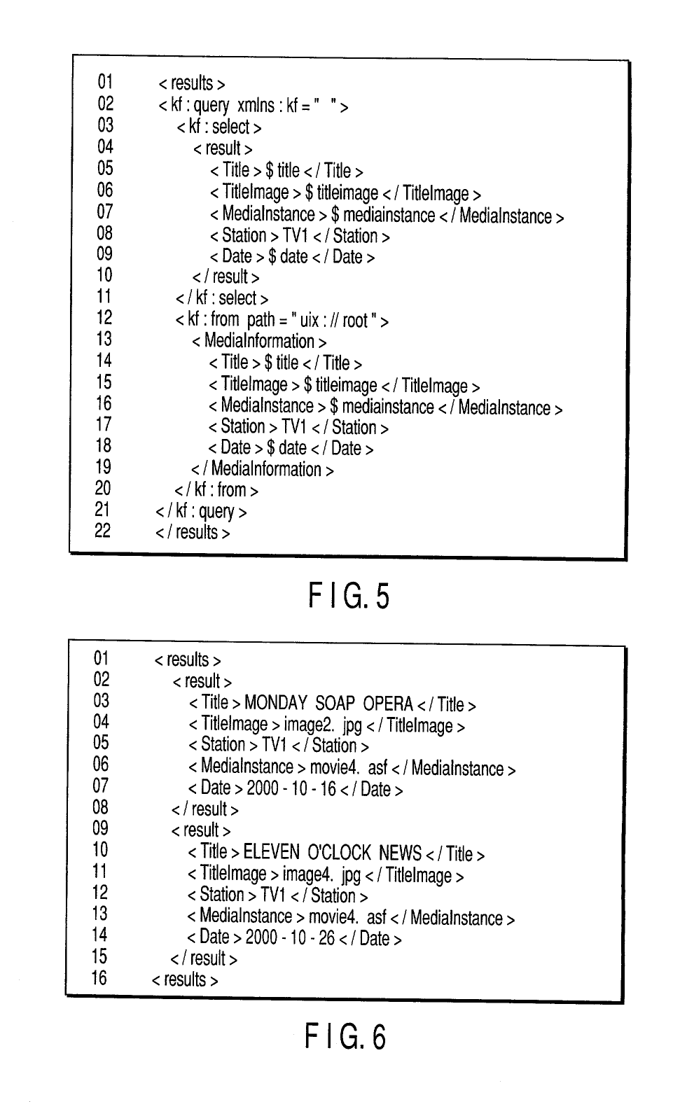

FIG. 5 illustrates one example of a query expression indicated as “qt_tv1.xml”. For convenience of explanation, line numbers are referred to the left of FIG. 5. This query is described with XML. This query comprises a <kf:query> tag, <kf:select> tag and <kf:from> tag. The <kf:query> tag and </kf:query> represent the start and end of the quiry expression, respectively. The <kf:select> and </kf:select> represent the start and end of the output format of the search result. The tags <kf:from> and </kf:from> represent where in a database should be retrieved.

In the example of FIG. 5, the inquiry expression is defined by <kf:query> tag of line 02 to </kf:query> tag of line 21. The data between the line 03 <kf:select> and line 11 </kf:select> define repeating the steps from the line 04 to line 10 whenever the database is retrieved. The data from <kf:from> tag of line 12 to </kf:from> tag of line 20 define whether there is the same data structure as that from line 13 to line 19 in a position in a database specified by a “path” attribute. When there are data, a value is bound by a variable started by “$”.

In the example of FIG. 5, only a <Station> tag of line 17 is a fixed value, and, the others <Title>, <TitleImage> and <Station> tags become variables. In this example, since a value of a <Station> tag is “TV 1”, the data from the line 09 to the line 15 of FIG. 4 is matched the data from the line 23 and line 29.

When a value of a <Station> tag matches that from line 09 to line 15 of FIG. 4, “movie2.asf” is bound in $ MediaInstance, a “Monday drama” in $ Title, and “image2.jpg” in $ TitleImage. When the tag value matches that from line 23 to line 29 of FIG. 4, the operation is performed similarly to the above. Then, a search result is output according to a format defined between lines 03 and 11 of FIG. 5. The search results output as described above are bound by <results> tag and </results> tag described in line 01 and line 22 of FIG. 5 and output.

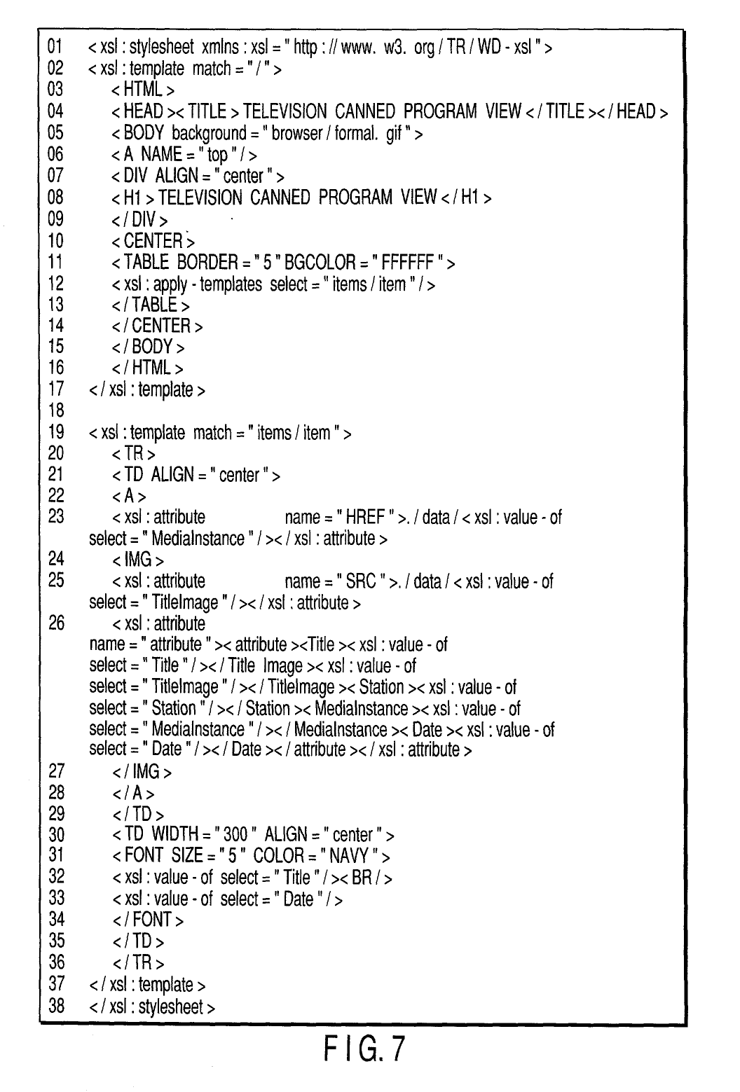

FIG. 6 shows an example of the search results searched in this way. When the search results shown in FIG. 6 are input to the search result converter 4, the search result converter 4 adds an attribute to the search results using a conversion rule shown in FIG. 7.

The conversion rule shown in FIG. 7 is described by XSLT (Extensible Stylesheet Language Transformations) (http://www.w3.org/TR/xslt.html cf. http://www.w3.org/TR/xslt.html) which is a rule to convert XML data to XML data. In this example, when the search results are converted to display the search results of FIG. 6 with a representative picture, an attribute is added to the search result as described in line 26 of FIG. 7. A search caption attribute includes a title, a representative picture name, a TV station name, a motion image file name and a record day which are provided as search results. If a process of this conversion is a process according to a standard of XSLT, it may be anything. Since the process is a general process, its explanation is omitted. The search caption attribute added here is used in a narrow down search and a similar search.

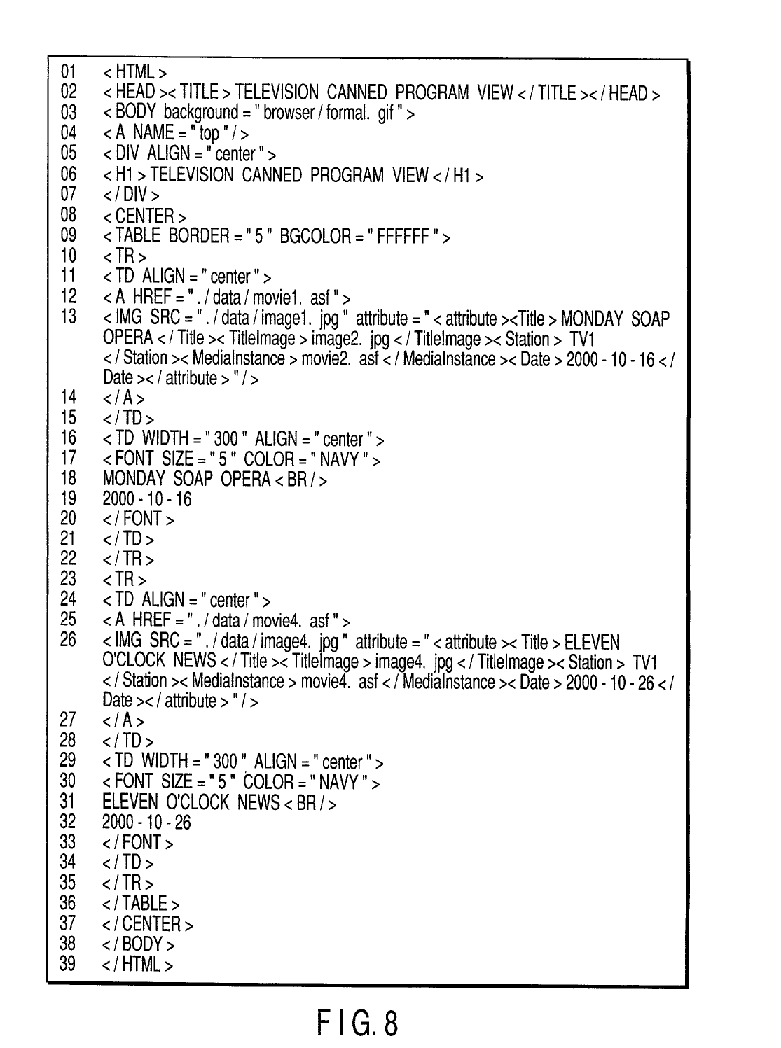

FIG. 8 shows one example of the converted search results and is described with XHTML. When the converted search results shown in FIG. 8 are input to the search result output device 5, the search result output device 5 displays the results on the screen 22 of FIG. 2 to provide the search results to a user. The screen 22 comprises, for example, a Web browser.

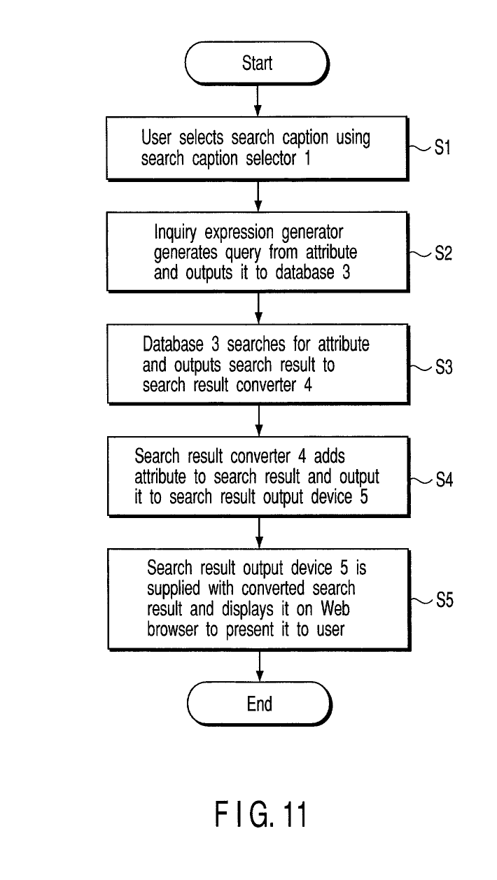

There will now be described a processing of the system according to the embodiment in conjunction with the flow chart of FIG. 11.

At first a user selects a search caption by means of the search caption selector 1 (step S1). Then, the inquiry expression generator 2 generates a query from a search caption attribute added to a search caption, and outputs it to the database 3 (step S2). The database 3 retrieves an attribute of multimedia data, and outputs search results to the search result converter 4 (step S3). The search result converter 4 adds the search caption attribute to the search results to convert them into attribute search results. The converted search results are output to a search result output device (step S4). When the converted search results are input to the search result output device 5, the search result output device 5 displays the search results to a Web browser to provide it to a user (step S5).

As thus described, when a search caption attribute is added to a search caption and search result, an operation when the search caption is selected can be set in flexible.

A modification of a multimedia data management system of the first embodiment is explained hereinafter.

In the search caption selector 1 of the first embodiment, a tree-shaped button on the screen is selected. However, the search caption is not limited to this. If it is a form that a user can give instructions of a search, it may be anything. The search caption may be, for example, GUI parts such as a check box, a radio button, a text box. The instructions of a search may be given by gesture and a hand gesture using an acceleration sensor mounted on an arm. In that case of text box, a free key word may be input.

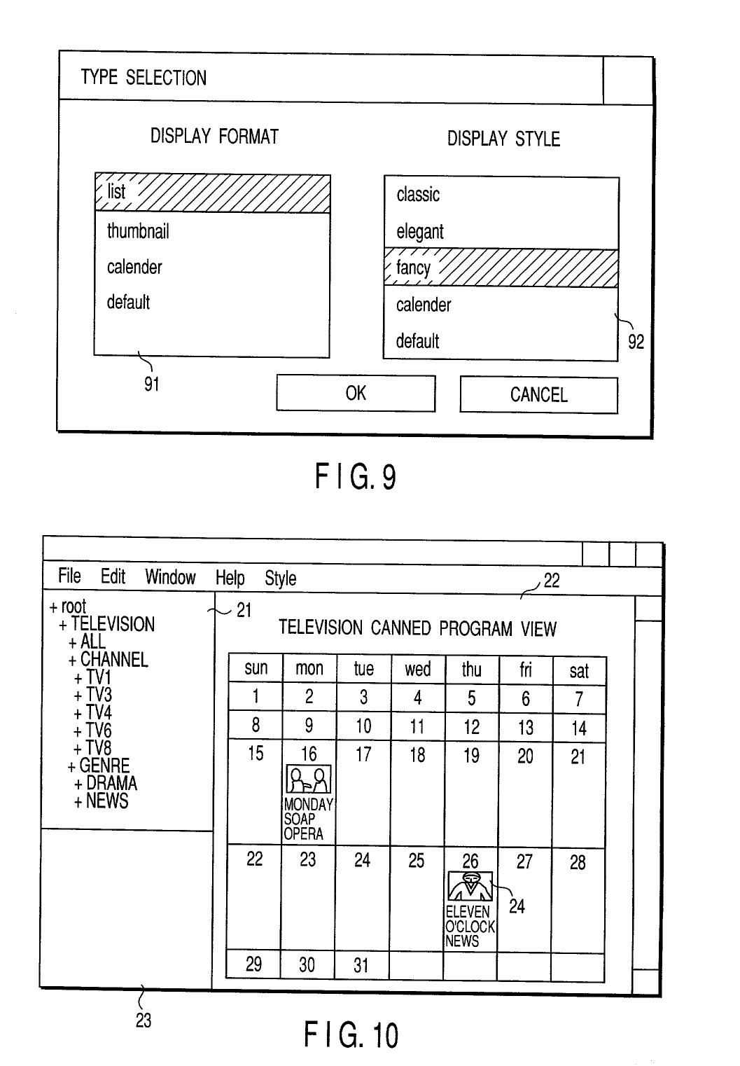

The search result converter 4 of the first embodiment adds a search caption attribute to the search result, but a display form (referred to as a style hereinafter) of search results may be selected. FIG. 9 shows an example of the screen that a user selects a style on the search result output device 5. This screen is activated by selecting a “style” menu of FIG. 2.

A screen 91 is a screen changing a display style. A list style, a thumb nail style, a calendar style, and a regulation style can be selected in this example. The list style screen 91 is displayed so that the display styles described by “type” attributes are not duplicated in the styles corresponding to the search captions stored in the search caption relation memory 6 shown in FIG. 3. A style is selected by clicking a style name, and a selected style is highlit.

A screen 92 is a screen changing the display appearance, and classical style, elegant style, fancy style, calendar style, regulation style can be selected in this example. This selection is performed by the same operation as step S1. When setting is completed, a style having a selected “type” attribute and “skin” attribute is selected by pushing an “OK” button. In an example of FIG. 9, fancy.xsl is selected as a style. FIG. 10 shows an example of the screen on which the same search results as FIG. 2 is displayed in the calendar style.

This style is selected by a user, but a method of selecting a style is not limited to the above method. If it is a method that can select one style, anything is preferable. Further, a style may be selected depending on the situation of a user. For example, when the user gives instructions of a search using a telephone, the user cannot watch a picture. In this case, a style of reading a synthetic speech may be selected automatically.

In the first embodiment, a search is performed every time when an instruction of a search is issued. However, when the same query as the query which executed at the past was carried out and data is not updated from the time point of the past, the search results generated in executing the query at the past and stored may be output as search results.

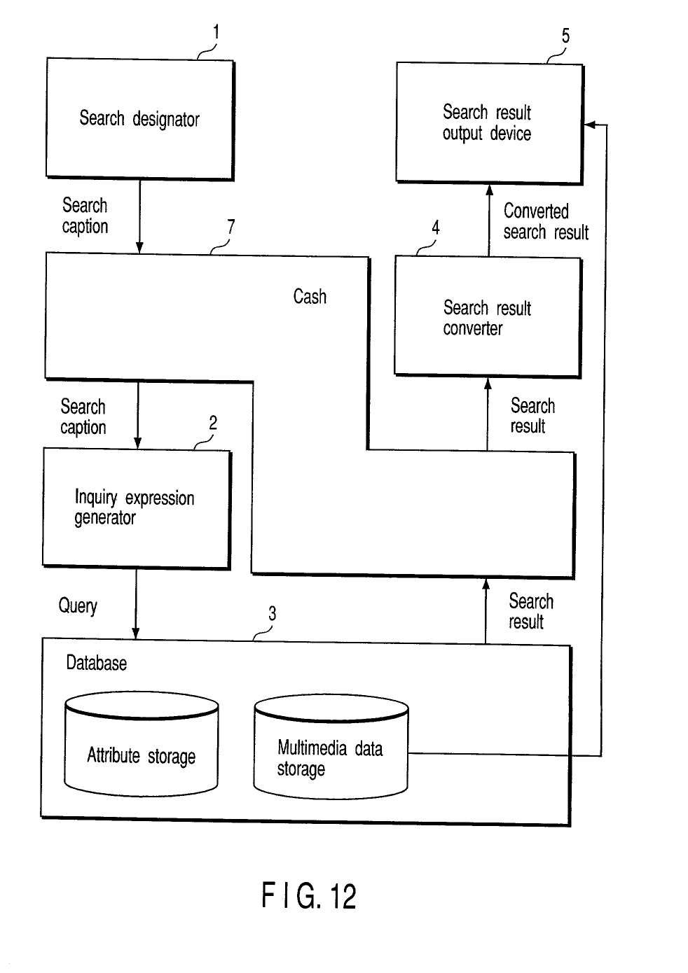

FIG. 12 shows a schematic configuration of a multimedia data management system that stores data temporally. In this system, a cash 7 is added between the search caption selector 1 and inquiry expression generator 2 and between the database 3 and search result converter 4. When a search caption is input to the cash 7 by the inquiry expression generator 2, if the same search caption is input at a past and the database is not updated, the past search results are output to the search result converter 4. Otherwise, the input search caption is output to the database 3, and the search results are output to the inquiry expression generator 4. The search caption and search results are stored in a table with 1 to 1. When the retrieval is newly performed, a pair of a search caption and a search result are added to the table. When data stored in the database 3 are updated, this table is cleared. Thus, a high-speed search is enabled. Since there are many cases that the search caption is fixed, there are a lot of opportunities using temporary storage of search results. Accordingly, the present embodiment is effective for such cases. Furthermore, a title character string used for the search caption can be used as items of the table, the size of a table can be reduced.

The search caption selector 1 used in the first embodiment selects one search caption at a time, but the search caption selector 1 may select plural search captions at a time. For example, a button associated with a query and a text box for inputting a free key word may be combined. In this case, a special variable, for example, $free_keyword is included in a query. The text input to the screen 23 of FIG. 2 and variable are substituted to each other by the query expression generator 2. Then, a free key word search may be performed.

In the first embodiment, when the search caption selector 1 uses plural search captions, combinations of search captions may be counted and the combination employed frequently may be registered as a new search caption automatically. In the case of a combination of a button and a free key word, when the frequency that input the same free key word is counted and the count frequency exceeds ten times, for example, a corresponding button may be registered as a new button automatically. This registration is performed by storing a search caption and a query in the search caption relation memory 6 with the search caption being associated with the query. A count of this use frequency may be carried out every user. Identification of a user is performed by inputting a user name in starting a program, for example. Therefore, a search caption can be customized every user.

The search caption of the first embodiment is fixed, but this may be generated in dynamic depending on the contents of a database. In data of FIG. 4, for example, when a large number of search captions for TV stations of the whole country are prepared beforehand, a large quantity of search captions for the TV stations which cannot be watched by a user must be displayed. Thus, only a TV station name stored by the database 3 may be employed as a search caption. In a case of generating the dynamic search caption, when generating this dynamic search caption, for example, the search caption selector issues a query returning only the stored TV station name to the database 3. The search results may be registered in the search caption relation memory 6. Then, the query also is generated in dynamic. Thus, the unnecessary search caption which is not stored in the database need not be displayed. This makes the confusion of the user reduce.

According to the first embodiment described above, when captions are displayed on the screen 21, if one of the captions, for example, “TV 1”is clicked by a user, an inquiry expression corresponding to the caption, that is, a query is generated. Using the query, the database 3 is searched for. The search result is converted to the graphical style by the converter 4.

The inquiry expression and the style are associated with each other. Classical style or Gothic style can be selected by changing a style.

That is, the search result is converted into graphical data according to the style. The graphical data is presented to a user by the search result output device 5.

### The Second Embodiment

The search caption selector 1 of the first embodiment selects a search caption, but may select a search result. When the representative picture icon 24 of a TV program displayed as a search result on the screen 22 of FIG. 2, for example, is selected, the inquiry expression generator 2 generate a query from a search caption attribute added to the icon 24.

When a user clicks the icon 24, the search caption selector 1 selects the icon 24 and outputs the search caption attribute added to this icon to the inquiry expression generator 2. In case of this example, the search caption attribute added to the icon 24 is described as shown in line 26 of FIG. 8. The search caption attribute is defined with “attribute”, and its contents are a character string of “<attribute> <title> eleven o'clock news </title> <TitleImage> image4.jpg </TitleImage> <Station> TV1 </Station> <MediaInstance> movie4.asf </MediaInstance> <Date> 2000-10-26 </Date> </attribute>” described with XML. The search caption attribute may be anything if it is information regarding to the search caption such as a name of a person displayed by an icon, a character name of a TV program represented with an icon. When a person name of an icon and the same person name are selected, a TV program on which the same person comes is subjected to analogous search.

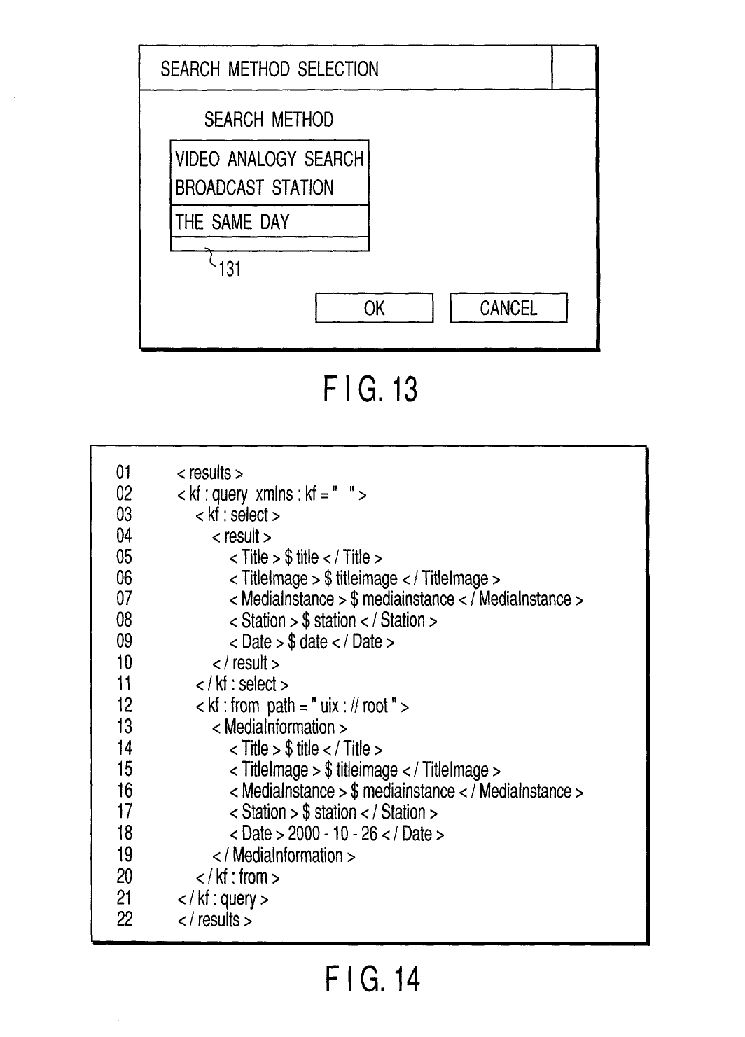

The inquiry expression generator 2 detects a <TitleImage> tag, and inquires to a user for what kind of search is performed. FIG. 13 shows an example of an inquiry screen of a search method. This screen specifies and enumerates a search method from a search caption attribute, and displays the search method in a list. In a case of specifying a search method, a search method and a search caption attribute are prepared with a one-on-one relation on a table so that the analogous search is executed if the tag is <TitleImage>. The screen 131 of FIG. 13 is a screen changing a display style. When “the same date” is selected, a query retrieving a TV picture recorded on the same date as that of the data is generated.

FIG. 14 shows an example of a query generated in this way. In the queries which generate the search results shown in FIG. 6, the content of <Date> is substituted with a concrete day, and the content of <Station> is substituted with a variable, so that the query is generated. Explanation is omitted because the following processing is performed as carried out in the first embodiment to display the search results.

As thus described, since a search caption attribute is added to a search caption and search results, a narrow down search and a similar search can be carried out in flexible. Accordingly, a user can retrieve information to want immediately.

### The Third Embodiment

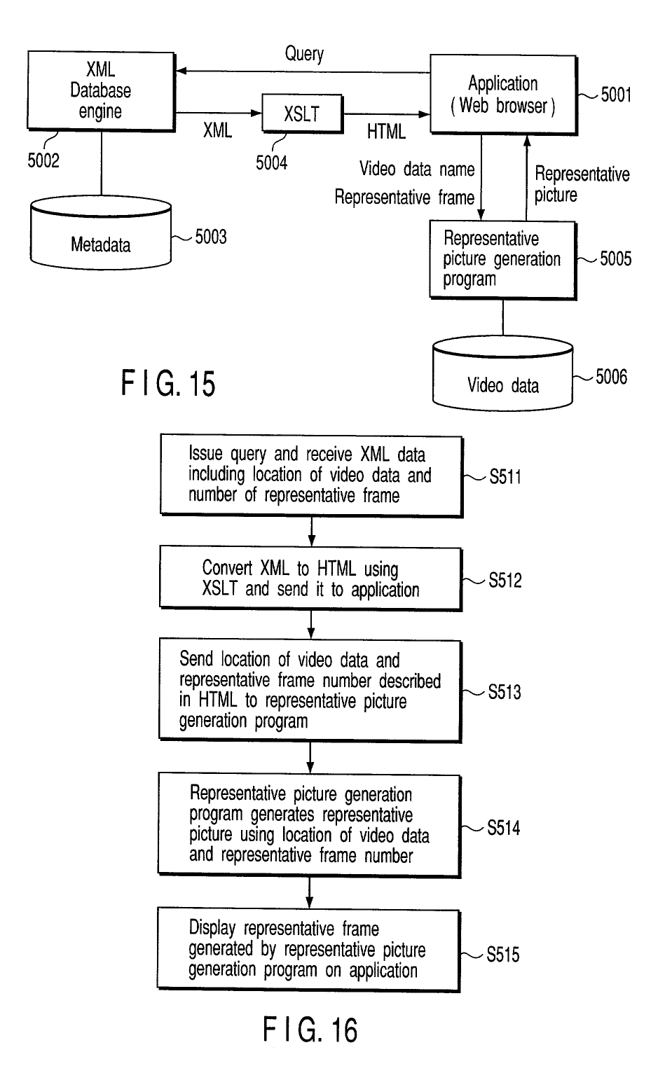

FIG. 15 shows a view explaining an information device and method for automatically generating a representative screen from picture data managed by a XML database. FIG. 16 shows a flow chart explaining a flow of processing.

In step S511, a query is issued to an XML database 5002 by an application 5001. The XML database engine 5002 retrieves a picture corresponding to metadata 5003 of a registered video and outputs an XML data including a location of the appropriate video data and the representative frame number. An application 5001 has a display function of HTML, in other words, is an application including a function of a Web browser and a Web browser, for example. The location of video data corresponds to a file name of a file arranged on the local disk and network, and is specified by URL and the like. The frame number is a generic term which can determine a specific frame in the video, and also represents a time stamp.

In step S512, XSLT5004 converts received XML data to HTML and transfers it to the application 5001.

In step S513, a location of video data described in HTML data transferred to the application 5001 and the representative frame number are transferred to a representative screen generation program 5005.

In step S514, the representative screen generation program 5005 reads video data stored by a storage 5006 according to a location of video data, and creates a representative picture from a frame of a position specified by the number of the representative frame. The created representative picture is transferred to the application 5001. In this time, the video data in itself may be transferred. A file name and URL to be necessary in order to refer to the file saving video data may be transferred.

In step S511, when plural videos appropriate to a query, steps S513 and S514 are repeated only the number of the appropriated videos to generate representative pictures corresponding to the videos, respectively.

In step S515, a picture of HTML transferred in step S512 and a picture of a representative frame generated in step S514 are merged and displayed on the application 5001.

In step S511, the representative frame number output from the XML database may use a fixed frame number such as a number identifying a frame in relation to the top of the video or a representative frame number registered every video as metadata beforehand.

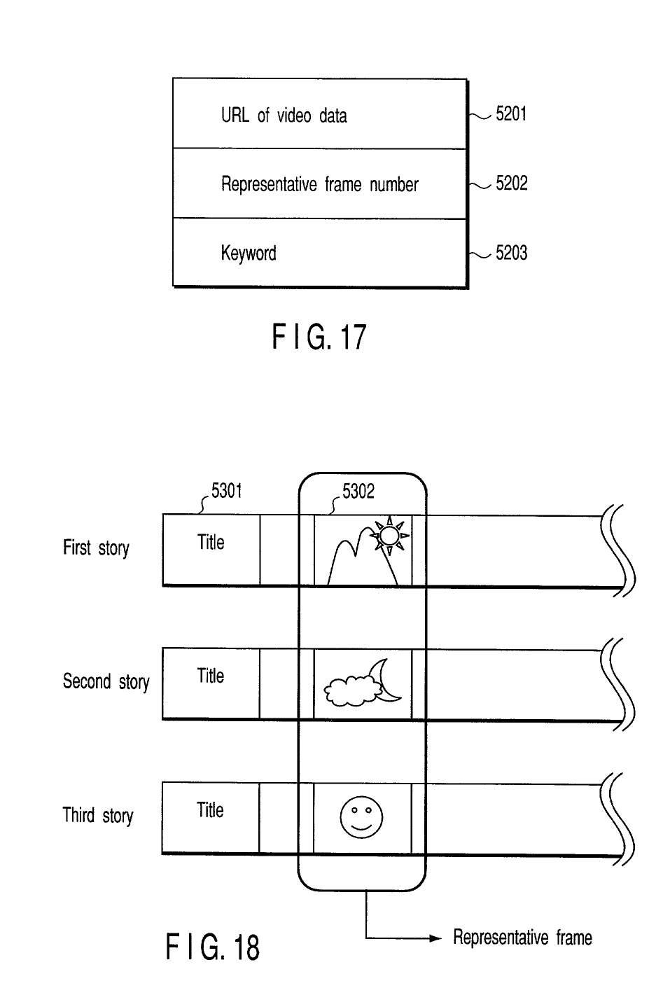

FIG. 17 shows an item example of metadata to describe the representative frame number. In URL 5201 of the video data is described a location of the corresponding video data using URL. The representative frame number 5202 is a representative frame corresponding to the video data. A key word 5203 is a key word corresponding to the video data.

Depending upon contents of a query and a genre of a registered video, there may be a case where an effective representative screen can be selected without use of the representative frame number described in the metadata.

For example, in a case that a key word extracted as metadata by a result of telop recognition or speech recognition is registered, and a desired video is retrieved by inputting a key word as a query, if a frame including an appropriate telop and speech is selected as a representative picture, the representative screen which reflects search results can be obtained.

There will now be described a method of selecting the representative frame picture which is every time different, from a program broadcasted regularly such as dramas in conjunction with FIG. 18.

It is general in a program broadcasted regularly such as dramas that an opening title 5301 is displayed in the beginning. When a representative frame picture is selected from this opening title according to the fixed frame number, the same picture can be obtained every time. Therefore, when stories of the same program are displayed as a list, the same representative pictures are aligned. Thus, if a representative frame 5302 is selected from a main program, an individual representative picture corresponding to each story can be displayed.

In a method to select a representative frame from the main program, where structure information of the program is described in addition to an item example of metadata of FIG. 17 or in stead of a representative frame number 5202, the structure information may be used. When a section of the opening and a section of the main program are described in the structure information, a representative picture is selected from the main program. Even if the section is not described clearly, if the section division is performed every shot, each shot is compared with the other from the top and the shot having a quantity of characteristic largely different from that of the others may be assumed as a starting shot of the main program. In a case that the section is not divided every section, each frame is compared with the other from the top, and the frame after a frame having a quantity of characteristic largely different from that of the others can be determined as the main program.

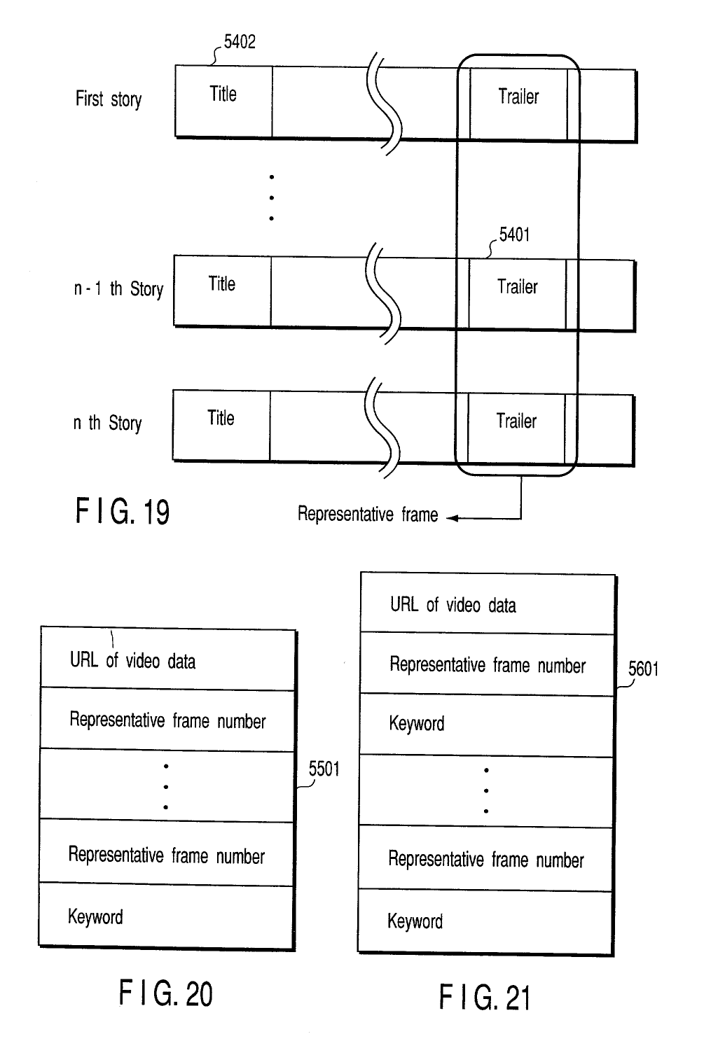

There will now be described another method to select the representative frame picture which is every time different among a program broadcasted regularly such as dramas in conjunction with FIG. 19.

In a program broadcasted regularly such as dramas, a trailer 5401 is often broadcasted in the last of the program. Thus if a representative picture is selected from a trailer of the last broadcast, the representative picture which is every time different can be selected. In other words, a trailer included in the (n−1)-th story is used as a representative picture of the n-th story. In this case, there is an advantage that a representative picture is created at a stage of a reservation in a reservation video recording of a program because the representative picture can be created before a program start.

In a case of broadcast of the first story, the last broadcast does not exist. Accordingly, a representative picture cannot be created by a trailer. Thus, for the first story, a representative frame is selected from a title 5402 of an opening or a main program. If a representative picture is selected from a title of the opening, particularly in the first story, when stories of the same program are displayed in a list, the title of the program and a trailer of each story are displayed. Therefore, the method is effective in order to grasp the contents.

If the section of the trailer is described clearly as metadata in order to determine the section of the trailer, the section may be used. There is a method to determine a telop to be inserted in a part of the trailer by using a telop recognition technology.

According to an information apparatus and method generating a representative picture automatically that are explained referring to FIG. 15, a single representative picture is generated for single video data. However, plural representative pictures can be generated. In this case, plural representative frames are registered in metadata 5003 for the single video data. As a result of a query for the XML database, XML data including plural representative frame numbers are output.

A representative picture generation program 5005 receives plural representative frame numbers together with a location of video data. The format of a representative picture generated in this time may be a style including plural pictures in the single video data as animation GIF. The plural video data may be generated and saved individually.

In a case of a format including plural pictures in the single video data as being animation GIF, if an application corresponds to this picture format, representative pictures are changed in turn automatically and can be displayed. Where plural video data are generated, generated individual video data may be read in turn, exchanged, and displayed.

FIG. 20 shows an item example of the metadata which are used for generating plural representative frame pictures automatically. Plural representative frames 5501 are described in FIG. 20. The representative picture is generated by these representative frames.

FIG. 21 shows an item example of the metadata which describes corresponding key words to the plural representative frame numbers, respectively. Plural pairs each including the representative frame number and a key word corresponding thereto are described as shown in 5601. If the metadata shown in FIG. 21 is applied to an information apparatus and method generating a representative picture automatically as shown in FIG. 15, an effective representative picture corresponding to a key word can be displayed. XML data including the representative frame number corresponding to an appropriate key word is output for a query issued to an XML database 5002.

This representative picture selection method is effective in classifying one program from various viewpoints. For example, when classifying a drama every actor, a name of the actor is used as a key word, and the frame that the actor appears is described in the metadata as the representative frame number. When a name of an actor is applied as a query to an information device and method shown in FIG. 15, a picture of the frame that the actor appears is provided as a representative picture. When a name of a different actor is given to the same drama as a query, the frame which is different in the same drama is provided as a representative picture.

In the embodiment, the representative picture is set up in the system.

However, the representative picture may use commercial available information which is held by an information provider such as the “Village Voice” providing image information and the like.

According to the present invention, the search caption which is the screen configuration element used for indicating a search by a user, a query which is a search expression and a style that is a rule to convert search results so that the user is easy to understand are managed so as to associate with one another. Therefore, search results of multimedia data having abundant expression can be watched depending on liking of the user by recycling a search caption, a query and a style.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multimedia data management system comprising:
a search caption selector configured to select one of a plurality of search captions to which attributes are added and which are presented to a user;
an inquiry expression generator configured to generate an inquiry expression corresponding to one of the attributes of the search captions;
a database which stores various media data and attributes of the media data and is searched by the inquiry expression to output a search result;
a converter configured to convert the search result to a converted search result by adding a style to the search result; and
a result output device configured to visually output the converted search result based on the style added thereto.

2. A multimedia data management apparatus according to claim 1, wherein the database includes a storage configured to store multimedia data including a motion video, a still video, a speech, a text, and data attributes.

3. A multimedia data management apparatus according to claim 1, wherein the database includes a storage configured to store attributes corresponding to inquiry expressions.

4. A multimedia data management apparatus according to claim 1, wherein the database comprises an XML database.

5. A multimedia data management apparatus according to claim 1, wherein the search caption selector include GUI elements representing a button, a check box, a radio button, and a free keyword input box, or a detector configured to detect a gesture instructing a specific search.

6. A multimedia data management apparatus according to claim 1, which includes a storage configured to store the search captions and search result conversion rules in association with one another, and the search result converter converts the search result according to the search result conversion rules.

7. A multimedia data management system according to claim 6, wherein the search result converter selects an optimum style according to a situation of the user, when a query representing the inquiry expression and at least one of the search result conversion rules are associated with each other in the storage.

8. A multimedia data management system according to claim 1, which includes a cash configured to store the search caption and search result in association with each other, the cash outputting the stored result when the same search caption as the stored search caption is designated by the user on the search caption presentation device and the database is not updated.

9. A multimedia data management system according to claim 1, wherein the inquiry expression generator includes a query synthesizer, and when the plural captions are selected on the search caption presentation device, the query synthesizer synthesizes the selected captions as a query.

10. A multimedia data management system according to claim 1, wherein the search caption selector adds the attribute to the search caption in dynamic according to the contents of the database.

11. A multimedia data management system according to claim 1, which includes a representative picture generator configured to generate a representative picture representing the search result from the contents stored in the database.

12. A multimedia data management system according to claim 11, wherein the representative picture generator generates the representative picture by searching for the picture using character recognition, telop recognition and speech recognition.

13. A multimedia data management system according to claim 11, wherein the representative picture generator generates the representative picture using an external motion video exterior of the system.

14. A multimedia data management system according to claim 11, wherein the representative picture generator generates a part of an appropriate motion video as the representative picture by recognizing a character string included in a query using picture recognition, telop recognition or speech recognition.

15. A multimedia data management system according to claim 1, wherein the result output device comprises a display configured to display a list style, a thumb nail style, a calendar style, and a regulation style
